(19) United States
(12) Patent Application Publication
(10) Pub. No.: US 2006/0206829 A1
(43) Pub. Date: Sep. 14, 2006

(54) Document searching apparatus

(75) Inventors: Noriyuki Komamura, Mishima-shi (JP); Nobuhiro Shimogori, Kawasaki-shi (JP); Koji Goto, Numazu-shi (JP); Seiya Shimizu, Numazu-shi (JP); Yoshikuni Matsumura, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/077,694

(22) Filed: Mar. 10, 2005

(51) Int. Cl. G06F 3/00; G06F 17/30; G06T 11/20

(52) U.S. Cl. 715/764; 345/440.2; 707/3

(57) ABSTRACT

A document searching apparatus stores, in a table, information indicating a size of each document which is a management object, and produces a document map which stacks and displays bars having sizes in accordance with the sizes of the respective documents which are the management objects to display in a display a screen having the produced document map, a pointer indicating one bar in the document map, and an image display region which displays an image of the document corresponding to the bar indicated by the pointer.

### BACKGROUND OF THE INVENTION

1. Field of the Invention

The present invention relates to a document searching apparatus which searches a document being managed using an information processing apparatus such as a computer.

2. Description of the Related Art

There has heretofore been a document searching apparatus by which a user searches for a desired document from a plurality of documents being managed. In this type of document searching apparatus, a display displays information indicating a state of the document being managed, information indicating a document being selected by user's operation and the like. Accordingly, the user searches for the desired document based on the information indicating the document displayed in the display.

For example, in Jpn. Pat. Appln. KOKAI Publication No. 11-328209, an image searching apparatus has been described in which the display displays information indicating a plurality of stored image data in order of time series based on time information of each image data. In this Jpn. Pat. Appln. KOKAI Publication No. 11-328209, the image searching apparatus has been described which displays only information indicating a distribution of each image data in the time series. However, in the image searching apparatus described in the Jpn. Pat. Appln. KOKAI Publication No. 11-328209, information other than the time information on the image data is not displayed. Therefore, there is a problem that a user cannot intuitively recognize information other than the time information.

### BRIEF SUMMARY OF THE INVENTION

According to the present invention, there is provided a document searching apparatus comprising: document managing means for managing a size of each document which is a management object; document map producing means for producing a document map which stacks and displays bars having sizes in accordance with the sizes of the respective documents managed by the document managing means; and displaying means for displaying a screen having the document map produced by the document map producing means, a pointer indicating one bar in the document map, and an image display region which displays an image of the document corresponding to the bar indicated by the pointer.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a constitution example of a document managing apparatus according to an embodiment of the present invention;

FIG. 2 is a diagram showing a constitution example of a mouse;

FIG. 3 is a diagram showing a display example of a document searching screen (display screen of a document) displayed in a display of the document managing apparatus;

FIG. 4 is a diagram showing display example of a part of a document map in the document searching screen;

FIG. 5 is a diagram showing a relation between a document managed by the document managing apparatus and an image displayed in an image display region;

FIG. 6 is a diagram showing a constitution example of a first file management table;

FIG. 7 is a diagram showing a constitution example of a second file management table;

FIG. 8 is a diagram showing a constitution example of a document management table;

FIG. 9 is a diagram showing a constitution example of the document management table;

FIG. 10 is a diagram showing a constitution example of the document management table;

FIG. 11 is a diagram showing a constitution example of a color management table;

FIG. 12 is a diagram showing a first constitution example of a bar size management table;

FIG. 13 is a diagram showing a second constitution example of the bar size management table;

FIG. 14 is a flowchart showing a registering process of document management information in the document managing apparatus;

FIG. 15 is a flowchart showing an image producing process in the document managing apparatus;

FIG. 16 is a flowchart showing a displaying process of the document searching screen in the document managing apparatus;

FIG. 17 is a flowchart showing a document map producing process in the document managing apparatus;

FIG. 18 is a flowchart showing a document searching process in the document managing apparatus;

FIG. 19 is a flowchart showing the document searching process in the document managing apparatus; and

FIG. 20 is a flowchart showing the document searching process in the document managing apparatus.

### DETAILED DESCRIPTION OF THE INVENTION

An embodiment of the present invention will be described in detail with reference to the drawings.

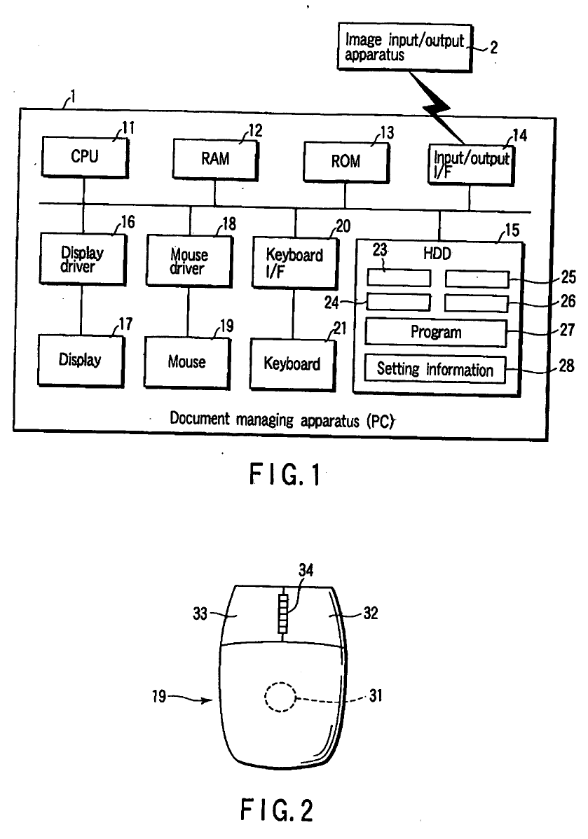

FIG. 1 is a block diagram schematically showing a constitution example of a document managing apparatus 1 according to an embodiment of a document searching apparatus of the present invention.

The document managing apparatus 1 functions as a document searching apparatus, and comprises a PC and the like connected to an image input/output apparatus 2. The image input/output apparatus 2 is not limited as long as the apparatus supplies an image to the document managing apparatus 1 which is the PC. Assumed examples of the image input/output apparatus 2 include a scanner, a digital complex machine (MFP) comprising the scanner, a digital camera, a computer on network (e.g., WWW server) and the like.

As shown in FIG. 1, the document managing apparatus 1 comprises a CPU 11, a RAM 12, a ROM 13, an input/output interface (I/F) 14, a hard disk drive (HDD) 15, a display driver 16, a display 17, a mouse driver 18, a mouse 19, a keyboard interface (I/F) 20, a keyboard 21 and the like. The mouse 19 and the keyboard 21 are input devices.

The CPU 11 executes a general control of the document managing apparatus 1. The CPU 11 executes a control program stored in the ROM 13 or an application program stored in the HDD 15 to thereby realize various functions. The RAM 12 is a memory which temporarily stores data for operation and the like. The ROM 13 is a nonvolatile memory in which a basic control program for operating the document managing apparatus (PC) 1 is stored beforehand.

The input/output interface 14 is an interface for inputting data such as an image from an external apparatus. In the constitution example shown in FIG. 1, the input/output interface 14 functions as an interface for acquiring an image from the image input/output apparatus 2. It is to be noted that FIG. 1 shows one input/output interface 14, but the document managing apparatus 1 may be provided with a plurality of input/output interfaces 14.

The HDD 15 is a storage device comprising a magnetic disk and the like. In the HDD 15, various types of data are stored in a file form. That is, the data constituting the document which is the management object of the document managing apparatus 1 is stored as a file in the HDD 15.

Moreover, the HDD 15 is provided with a first file management table 23 which is a data table, a second file management table 24, a document management table 25, a color management table 26, a bar size management table 27 and the like.

The first and second file management tables 23 and 24 are tables to store management information (file management information) concerning the file of the data constituting the document which is the management object. The document management table 25 is a table to store management information (document management information) on the document which is the management object. The color management table 26 is a table to store information (color management information) on a color associated with the document which is the management object. The bar size management table 27 is a table in which information is stored for determining a size (length) of each bar corresponding to each document displayed in a document map described later. It is to be noted that the respective data tables 23 to 26 will be described later in detail.

Moreover, the HDD 15 stores at least setting information 28, and an application program (program for document management) 29 for allowing a PC to function as the document managing apparatus 1.

The program 29 for document management comprises a program for allowing the PC to execute various types of processes such as a registering process of the document management information, an image producing process, a displaying process of a document searching screen, a document map producing process, and a document searching process. That is, when the program 29 for document management is executed, the PC realizes various types of functions such as a function of registering the document management information, a function of producing an image, a function of displaying the document searching screen, a function of producing the document map (bar for searching), and a function of searching the document.

The display driver 16 comprises a driving circuit which controls display contents of the display 17. The display driver 16 functions as an interface which outputs a signal of an image displayed in the display 17 to the display 17. The mouse driver 18 comprises a circuit which detects information input into the mouse 19 and the like. The mouse driver 18 detects movement of the mouse 19, input into a button disposed in the mouse 19, a rotation amount of a wheel disposed in the mouse 19 or the like. The mouse driver 18 notifies the CPU 11 of a signal indicating movement of the mouse 19, the input into the button of the mouse 19, the rotation amount of the wheel of the mouse 19 or the like.

The keyboard interface 20 detects information input in the keyboard 21, and notifies the CPU 11 of the information. The keyboard 21 comprises a plurality of keys of characters, numerals, symbols and the like. The input into each key of the keyboard 21 is detected by the keyboard interface 20, and notifies to the CPU 11 as a signal indicating the input key.

FIG. 2 is a diagram showing a constitution example of the mouse 19.

As shown in FIG. 2, the mouse 19 has an operation detection mechanism 31, a right button 32, a left button 33, a wheel 34 and the like. The mouse 19 is operated in a state shown in FIG. 2 when laid on a flat face. The mouse 19 having the state shown in FIG. 2 is held with user's hand. The user moves the mouse 19 having the state shown in FIG. 2 on the flat face, and operates the right button 32, left button 33, and wheel 34 if necessary.

The operation detection mechanism 31 is a mechanism for converting the movement of the mouse 19 on the flat face into a signal. For example, the operation detection mechanism 31 comprises a spherical body which rotates in accordance with the movement of the mouse 19, and a mechanism which converts the movement of the spherical body into the signal. The operation detection mechanism 31 may comprise an optical sensor which detects the movement of the mouse 19 on the flat face, the mechanism which converts the movement of the mouse 19 detected by the optical sensor into a signal. The operation detection mechanism 31 is disposed on a side brought into contact with the flat face in the state shown in FIG. 2. That is, when the user moves the mouse 19 held in the state shown in FIG. 2, the operation detection mechanism 31 detects the movement of the mouse 19 on the flat face. The signal indicating the movement of the mouse detected by the operation detection mechanism 31 is output to the mouse driver 18.

The right button 32 is a button disposed on the right side of a mouse 19 main body in the state shown in FIG. 2. The right button 32 is a button operated by user's index finger, middle finger or the like in a case where the user holds the mouse 19 main body having the state shown in FIG. 2 with user's right hand. The left button 33 is a button disposed on the left side of the mouse 19 main body in the state shown in FIG. 2. The left button 33 is operated by user's middle finger, third finger or the like in a case where the user holds the mouse 19 main body having the state shown in FIG. 2 with user's right hand.

The wheel 34 is a rotary member disposed in the vicinity of a middle portion of the mouse 19 in the state shown in FIG. 2. In the example shown in FIG. 2, the wheel 34 is disposed between the right button 32 and the left button 33. For example, the wheel 34 is operated with the index finger, middle finger, third finger or the like of the user who holds the mouse 19 main body having the state shown in FIG. 2.

Moreover, the wheel 34 is disposed in such a manner as to rotate only in a certain direction. In the example shown in FIG. 2, the wheel 34 rotates in a direction an inward direction (upward direction of FIG. 2) and a reverse direction (downward direction of FIG. 2). In the following description, as to the rotation direction of the wheel 34, it is assumed that an inward (upward in FIG. 2) rotation direction is a positive direction, and a frontward (downward in FIG. 2) rotation direction is the reverse direction.

Furthermore, the wheel 34 may function as a button. In this case, the wheel 34 is constituted in such a manner as to perform a specific input, when the wheel 34 itself is pressed. Additionally, the wheel 34 may be constituted in such a manner as to perform a specific input, when pressed toward the right or left.

Next, a display screen (document searching screen) will be described with respect to the document managed by the document managing apparatus 1.

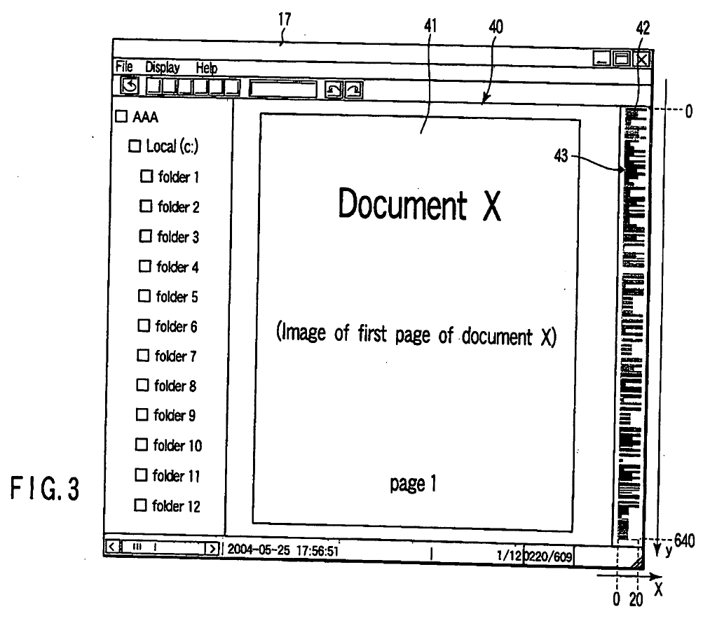

FIG. 3 is a diagram showing a display example of a document searching screen (display screen of the document) 40 displayed in the display 17 of the document managing apparatus 1.

In the document managing apparatus 1, the document searching screen 40 is displayed in a display window displayed in the display 17. As shown in FIG. 3, the document searching screen 40 displays an image of each page constituting the document managed by the document managing apparatus 1 every page unit in accordance with user's operation. The user searches the desired document with reference to the image displayed in the document searching screen 40 shown in FIG. 3.

In the display example shown in FIG. 3, the document searching screen 40 displays tool bars including various types of operation keys, and additionally an image display region 41, a document map (bar for searching) 42, a pointer (arrow) 43 and the like.

The image display region 41 is a substantially middle region of a display window which is the document searching screen 40 displayed in the display 17. Images of one or a plurality of pages constituting the document are displayed every page unit in accordance with user's operation in the image display region 41.

The document map 42 is displayed in a right-end region of the document searching screen 40. The document map 42 comprises a plurality of bars. Each bar corresponds to each document managed by the document managing apparatus 1. That is, in the document map 42, the respective bars (lines) indicating the respective documents are stacked and displayed.

The pointer 43 is displayed in a region adjacent to the document map 42 in the document searching screen 40. The pointer 43 indicates a position of the bar on the document map 42, and the bar indicates a document to which the image displayed in the image display region 41 belongs. That is, the pointer 43 indicates the position of the bar indicating the document being displayed in the document map 42.

Next, a constitution of the document map 42 will be described in detail.

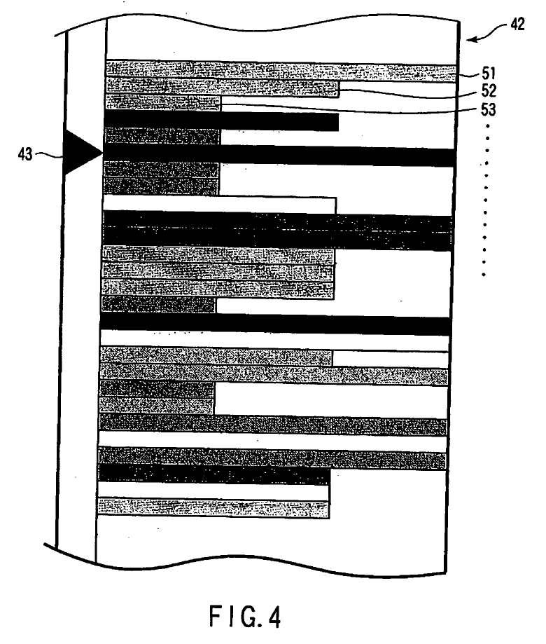

FIG. 4 is a diagram showing a display example, in which a part of the document map 42 is enlarged.

As described above, in the document map 42, bars 51, 52, 53, . . . indicating the respective documents managed by the document managing apparatus 1 are stacked and displayed.

In the document map 42, the respective bars 51, . . . corresponding to the respective documents are stacked and displayed in a vertical direction of a display screen in “order” of the respective documents managed by the document management table 25. In the document map 42, the respective bars 51, . . . corresponding to the respective documents are displayed in colors associated with the respective documents. In the document map 42, the respective bars 51, . . . corresponding to the respective documents are displayed in sizes in accordance with sizes of the respective documents.

Next, constitutions of the respective bars 51, . . . displayed in the document map 42 will be described.

In the document map 42, the respective bars 51, . . . indicating the respective documents are stacked and displayed in the vertical direction of the display screen in “order” of the respective documents managed by the document management table 25. In the present embodiment, as described later, the document management table 25 manages the “order” of the respective documents in order of a document time based on the document time of each document. Therefore, in the present embodiment, in the document map 42, the respective bars 51, . . . indicating the respective documents managed by the document managing apparatus 1 are stacked and displayed in order of time series in the vertical direction of the display screen. This shows a state in which the respective documents managed by the document managing apparatus 1 are stacked in order of time series.

In a display example of the document map 42 shown in FIG. 3, the uppermost bar indicates a document (newest document) having a latest document time, and the lowermost bar indicates a document (oldest document) having an oldest document time. That is, in the document map 42 shown in FIG. 3 or 4, as to the respective stacked bars, the upper bars indicate newer documents, and the lower bars indicate older documents.

Next, colors of the respective bars 51, . . . in the document map 42 will be described.

The respective bars 51, . . . corresponding to the respective documents displayed in the document map 42 are displayed in various colors. It is to be noted that since the display example of the document map 42 shown in FIGS. 3 and 4 is monochromatic, the colors of the respective bars 51, . . . are indicated by shading. The colors of the respective bars 51, . . . corresponding to the respective documents displayed in the document map 42 are set in accordance with a storage place of a file which is the document, a type of the file which is the document and the like. The colors of the respective bars 51, . . . corresponding to the respective documents displayed in the document map 42 are managed by the color management table 26.

For example, the colors of the respective bars 51, . . . corresponding to the respective documents displayed in the document map 42 are set for each folder in which the file of data constituting the document is stored. In this case, the respective bars showing the documents whose files are stored in the same folder are displayed in the same color, and the respective bars indicating the documents whose files are stored in different folders are displayed in different colors. Accordingly, by the color of the bar displayed in the document map 42, the user can intuitively recognize the folder in which the file is stored as the document.

It is to be noted that the colors of the respective bars 51, . . . corresponding to the respective documents displayed in the document map 42 may be set for each extension of the file which is the document or each application for opening the document. In this case, the user can intuitively recognize the data form of the file which is the document or the folder in which the application corresponding to the file is stored by the color of the bar displayed in the document map 42.

Next, the sizes of the respective bars 51, . . . in the document map 42 will be described.

As shown in FIGS. 3 and 4, the respective bars 51, . . . are displayed in various sizes in the document map 42. In the present embodiment, it is assumed that the sizes of the respective 51 are widths (lengths) of a lateral direction in the display screen.

The sizes of the respective bars 51, . . . corresponding to the respective documents displayed in the document map 42 are determined based on information indicating a relation between the sizes of the document and the bar stored in the bar size management table 27. The above-described “size of the document” is the size of the document as the data (data size of the file which is the document), page number corresponding the document or the like. The present embodiment will be described later with respect to a case where the size of the bar is set in accordance with the data size (file size) of the file and a case where the size of the bar is set in accordance with the number of the pages constituting the document by the bar size management table 27.

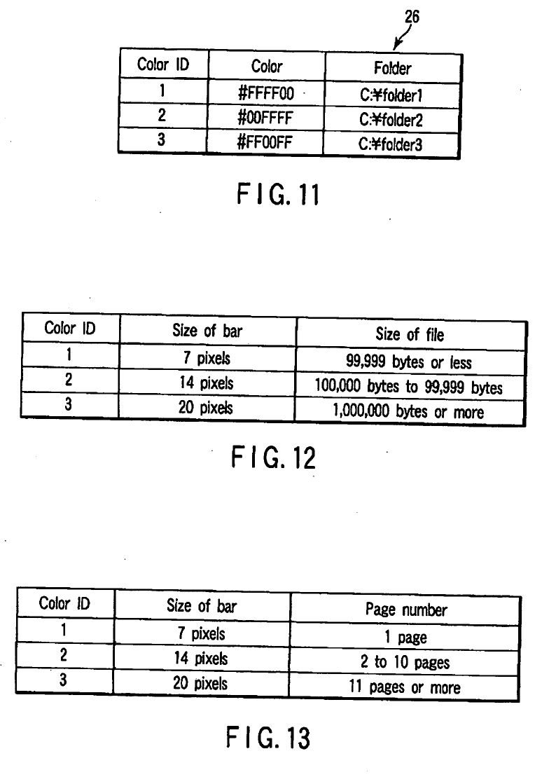

For example, to set the size of the bar in accordance with the file size, in the bar size management table 27, information is stored which indicates the bar size with respect to the file size (see, e.g., FIG. 12). In this case, as to the respective bars 51, . . . corresponding to the respective documents displayed in the document map 42, the sizes are determined in accordance with the file sizes of the files which are managed as the documents by the bar size management table 27. Accordingly, the respective bars 51, . . . constituted in a plurality of sizes are displayed in the document map 42.

It is to be noted that in the bar size management table 27, the bar size may be set beforehand in a plurality of stages with respect to the file size. Further in the bar size management table 27, a relative bar size may be set based on the file size of the file of each document which is a management object. For example, in a display example shown in FIG. 4, the respective bars are displayed in three stages of sizes. In this case, the file sizes are set in accordance with three bar sizes in the bar size management table 27.

Moreover, to set the bar size in accordance with the number of pages of the document, information is stored which indicates the bar size with respect to the page number in the bar size management table 27 (see, e.g., FIG. 13). In this case, as to the respective bars 51, . . . corresponding to the respective documents displayed in the document map 42, the sizes are determined in accordance with the number of the pages constituting the document. Accordingly, the respective bars 51, . . . constituted in a plurality of sizes are displayed in the document map 42.

It is to be noted that in the bar size management table 27, the bar size may be set beforehand in a plurality of stages with respect to the page number. Further in the bar size management table 27, a relative bar size may be set based on the number of the pages of each document which is a management object. For example, in the display example shown in FIG. 4, the respective bars are displayed in three stages of sizes. In this case, the page numbers are set in accordance with three bar sizes in the bar size management table 27.

As described above, in the document map 42, the respective bars 51, . . . indicating the respective documents are stacked and displayed in the vertical direction of the display screen in order of the document time, each bar is displayed in the color in accordance with the storage place or the type of the file, and each bar is displayed in a length in accordance with the file size in the lateral direction of the display screen.

Next, switching of an image will be described which is displayed in the image display region 41 of the document searching screen 40.

FIG. 5 is a diagram showing a relation between a document managed by the document managing apparatus 1 and an image displayed in the image display region 41.

Each document managed by the document managing apparatus 1 is constituted of one or a plurality of pages as shown in FIG. 5. The image shown in the image display region 41 of the document searching screen 40 shown in FIG. 3 is switched in response to an input of the mouse 19 or keyboard 21. The switching of the image displayed in the image display region 41 includes the switching of the document and the switching of the page.

In the document managing apparatus 1, as shown in FIG. 5, a plurality of documents are managed in order of time series based on a document time such as a document preparation time and an update time. The order of each document is also reflected in display order of the bar corresponding to each document stacked and displayed in the document map 42. Therefore, as shown in FIGS. 3 and 4, the bars corresponding to the respective documents are stacked/displayed in order of time series in the document map 42.

Furthermore, in the document managing apparatus 1, as shown in FIG. 5, a plurality of pages in each document are managed in order of page.

In the document managing apparatus 1, the document displayed in the document searching screen 40 is switched in response to the operation of the mouse 19 or the keyboard 21 in a vertical direction (up/down direction of FIG. 3). Further in the document managing apparatus 1, the page displayed in the document searching screen 40 is switched in response to the operation of the mouse 19 or the keyboard 21 in a lateral direction (right/left direction of FIG. 3).

That is, when the user performs the operation in the vertical direction with the mouse 19, the keyboard 21 or the like, the document managing apparatus 1 switches the document to be displayed in the image display region 41 of the document searching screen 40. As a result, the image display region 41 of the document searching screen 40 displays a representative image (e.g., the image of a first page of the document) of the document switched in response to the operation in the vertical direction by the user. When the user performs the operation in the lateral direction with the mouse 19, the keyboard 21 or the like, the document managing apparatus 1 switches the page to be displayed in the image display region 41 of the document searching screen 40. As a result, the image display region 41 of the document searching screen 40 displays an image of the page switched in response to the operation in the lateral direction by the user.

First, the switching will be described with respect to the image to be displayed in the image display region 41 of the document searching screen 40 every document unit.

The document is switched, when the user instructs the switching of the document by an input device, for example, the mouse 19, the keyboard 21 or the like. Here, as described above, the document which is the image to be displayed in the image display region 41 is switched in response to the operation in the vertical direction (up/down direction). For example, the document is switched in response to the input into an up/down cursor key (up and down keys) of the keyboard 21, or the operation in the vertical direction by the pointing device like the mouse 19 or the like. In the present embodiment, the operation in the vertical direction will be described with respect to the switching of the document in accordance with a rotation amount of the wheel 34 of the mouse 19, which rotates in a forward/backward direction. The switching of the document by the wheel 34 of the mouse 19 will be described later in detail.

When the document is switched by the above-described operation, the image of the first page is displayed as the representative image of the document in the image display region 41 of the document searching screen 40. That is, every time the document is switched by the mouse 19, the keyboard 21 or the like, the image of the first page of each document is successively displayed in the image display region 41. It is to be noted that a specific page among the respective pages of the document may be set as the representative image of each document.

That is, to switch the representative image (image of the first page) of the document displayed in the image display region 41, the user instructs the switching of the document by the input device like the mouse 19 or the keyboard 21. Then, the document managing apparatus 1 successively switches the image of the first page of the document displayed in the image display region 41 in order of time series of each document.

Next, a case will be described where the image displayed in the image display region 41 of the document searching screen 40 is switched every page unit.

The page is switched, when the user instructs the switching of the page by the input device like the mouse 19, the keyboard 21 or the like. Here, as described above, the page which is the image to be displayed in the image display region 41 is switched in response to the operation in the lateral direction. For example, the page is switched in response to the input into a right/left cursor key (right and left keys) of the keyboard.

Every time the page is switched by the above-described operation, the image of each page constituting the document being displayed is successively displayed in the image display region 41 of the document searching screen 40. That is, to display the specific page of the specific document in the image display region 41, the user first displays the image of the first page of the desired document in the image display region 41 by the above-described switching of the document. In this display state, the user instructs the switching of the page by the mouse 19 or the keyboard 21. Then, the document managing apparatus 1 successively displays the image of each page constituting the document being displayed in the image display region 41 in order of page.

Next, various types of data tables 23 to 26 will be described for managing the document in the document managing apparatus 1 constituted as described above.

In the document managing apparatus 1, the data constituting each document which is a management object is stored as a file in the HDD 15. The file of the data constituting the document stored in the HDD 15 is managed by the first and second file management tables 23, 24. Management information of the document corresponding to the file stored in the HDD 15 is managed by the document management table 25. The color of the bar is managed by the color management table 26. This bar indicates each document in the document map 42 of the document searching screen 40.

First, the first and second file management tables 23, 24 will be described.

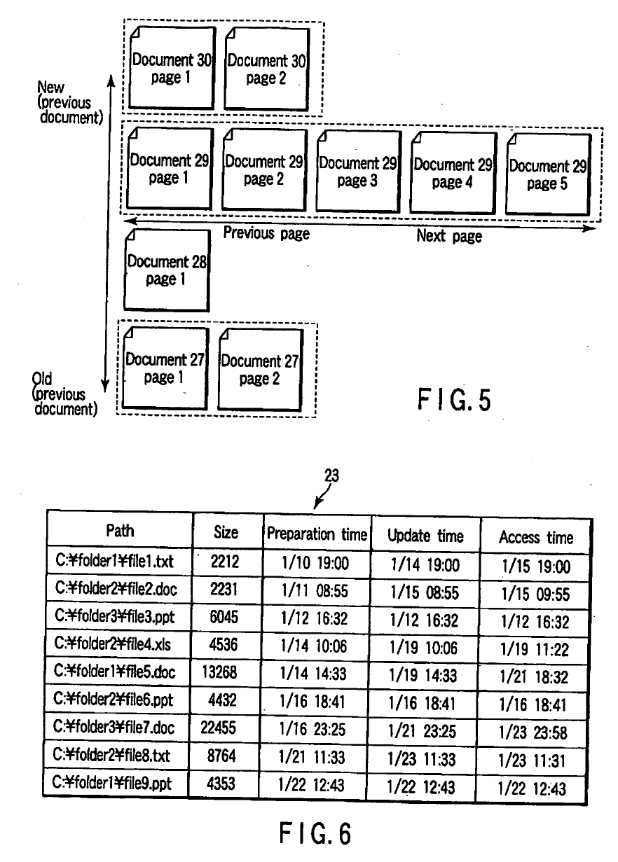

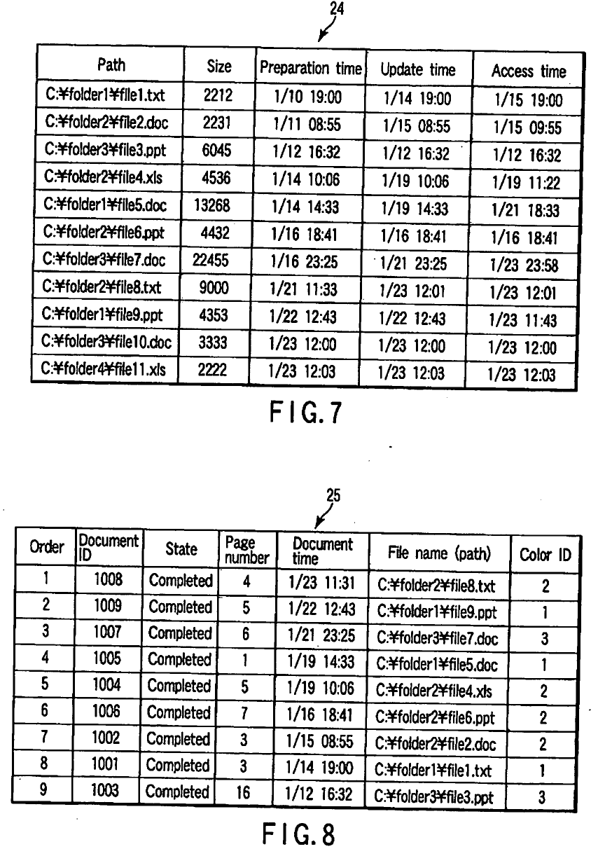

FIG. 6 is a diagram showing a constitution example of the first file management table 23. FIG. 7 is a diagram showing a constitution example of the second file management table 24.

The first and second file management tables 23, 24 are tables to store the management information on each file which is each document managed by the document managing apparatus 1.

As shown in FIGS. 6 and 7, the first and second file management tables 23, 24 are constituted to store the management information of each file, including a path, size, preparation time, update time, access time and the like.

As the path, information indicating a file name of the file is stored together with the information indicating names of a drive and a folder in which the file exists. A data size of the file is stored as the size. A date when the file was prepared is stored as the preparation time. A date when the file was updated is stored as the update time. As the access time, a date when the file was last accessed is stored.

Moreover, the management information of each file at a past time is stored in the first file management table 23. Here, the past time means, for example, a time when the document managing apparatus 1 was previously started. On the other hand, the second file management table 24 shows a list of existing files. Therefore, the second file management table 24 is updated in response to update and addition of the file at any time.

For example, when the document managing apparatus 1 is started, the information of the second file management table 24 at this time is stored as a first file management table, and a new second file management table 24 is prepared (updated). In the second file management table 24, management information is stored concerning a newly added file and an updated file. In other words, a difference between the file at the previous starting time and that at the present starting time appears as a difference between the first and second file management tables 23, 24. In the present embodiment, an updated situation (new registration or update) of the file is judged by the difference between the first and second file management tables 23, 24.

Here, as an example of the new registration of the file, a case is assumed where the document managing apparatus 1 acquires a document comprising a plurality of pages of images via the input/output interface 14. In this case, the data of the document acquired via the input/output interface 14 is stored as the newly registered file in the HDD 15. In this case, a field is added to the second file management table 24 in such a manner as to store the management information on the file, and a path, size, preparation time, update time, access time and the like are stored as the management information of the newly registered file. It is to be noted that in this case the information of the first file management table 23 is held without being changed.

Moreover, as an example of the update of the file, the update is assumed with respect to a file whose management information exists in the second file management table 24. In this case, the updated file is overwritten/stored in the existing file in the HDD 15. In this case, the management information of the file in the second file management table 24 is rewritten based on the file whose information has been updated including the size, update time, access time and the like. It is to be noted that also in this case, the information of the first file management table 23 is held without being changed.

Next, the document management table 25 will be described.

FIGS. 8, 9, and 10 are diagrams showing constitution examples of the document management table 25.

The document management table 25 is a table for managing as the document the file managed by the first file management table 23. As shown in FIGS. 8, 9, and 10, in the document management table 25, an order, document ID, state, page number, document date, file name, color ID and the like are stored as the management information on the document.

Information indicating a display order of each document is stored as the order. As described above, the respective documents are displayed in order of time series based on the document time in the document searching screen 40 shown in FIG. 3. Therefore, the order of each document is manufactured in a descending order of the document time in the document management table 25.

As the document ID, unique ID information is stored which is applied to each document in such a manner as to identify each document.

As the state, information is stored which indicates a processed state of each document is stored. For example, information indicating an “updated” state or a “completed” state is stored. The “completed” state indicates that the update (update or new registration) of the document has been completed. The “updated” state indicates that the document is waiting for the update (update or new registration).

As the page number, information is stored which indicates the page number of the document. The page number is determined, when the document is brought into the “completed” state.

As the document time, preparation or update time is stored with respect to each document. For example, as the document time, the update time is stored with respect to the file corresponding to the document managed in the first file management table 23.

As the file name, information is stored which indicates the file corresponding to the document. For example, as the file name, a drive name, folder name, and file name are stored with respect to the file corresponding to each document.

As the color ID, information is stored which indicates a color for displaying the information indicating each document. The color ID is unique ID information applied to each color for identifying the color. It is to be noted that the color management table 26 shows information indicating an actual color corresponding to the color ID.

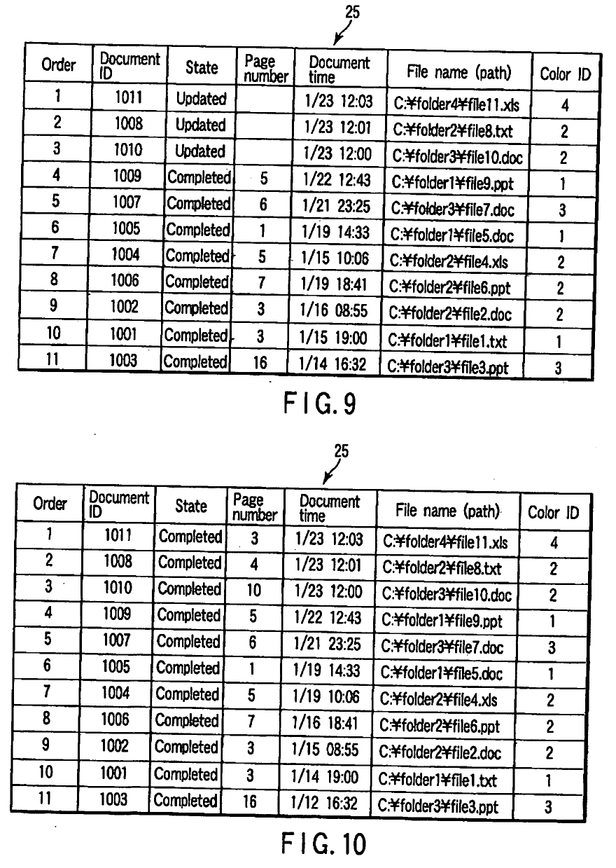

Moreover, the document management table 25 is updated by registration of the document management information described later. For example, nine documents are managed in the document management table 25 shown in FIG. 8. It is assumed that the document having document ID “1008” is updated, and documents having document IDs “1010” and “1011” are newly added in this state. In this case, in the registration of the document management information described later, three documents (document IDs “1008”, “1010”, “1011”) whose states have been set to be “updated” are registered in the document management table 25 shown in FIG. 8. In this case, the document management table 25 is prepared as shown in FIG. 9.

Furthermore, in the document management table 25 shown in FIG. 9 three documents having document IDs “1008”, “1010”, “1011” are brought into the “updated” states, and stored. As to the document set to the “updated” state in the document management table 25, images are successively produced as described later. When this image production is completed, the state of the document is rewritten into the “completed” state. Therefore, when the image production is completed with respect to three documents having the document IDs “1008”, “1010”, “1011”, the document management table 25 shown in FIG. 9 is rewritten into that shown in FIG. 10.

It is to be noted that the number of pages of each document is determined by the number of images produced by the image production described later. Therefore, in the document management table 25, as shown in FIG. 9, page-number columns of the respective documents brought into the “updated” states are blank. When the “updated” state of the document is changed into the “completed” state, as shown in FIG. 10, the number of images produced by the image production described later is stored as the page number.

Next, the color management table 26 will be described.

FIG. 11 is a document map showing a constitution example of the color management table 26.

In the color management table 26, the color ID, color (information indicating the actual color), and folder are associated. As described above, the color associated with each document is represented by the color ID in the document management table 25. Therefore, the color corresponding to each document is judged by the color ID of the document management table 25 and the color of the color management table 26. It is to be noted that the color associated with each document is the color of the bar corresponding to each document displayed in the document map 42 of the document searching screen 40.

Moreover, as described above, in the present embodiment, the color of the bar corresponding to each document displayed in the document map 42 of the document searching screen 40 is set for each folder. Therefore, in the color management table 26, as shown in FIG. 11, the color ID and the color are shown corresponding to each folder. It is to be noted that to set the color of the bar corresponding to each document displayed in the document map 42 for each extension of the file or each application for opening the document, in the color management table 26, the color ID and the color are stored corresponding to each extension or application.

Next, the bar size management table 27 will be described.

FIG. 12 is a diagram showing a first constitution example of the bar size management table 27. FIG. 13 is a diagram showing a second constitution example of the bar size management table 27.

The bar size management table 27 is a table to store information indicating a relation between the document size and the bar size. Here, the assumed document size is data size (file size) of the file managed as the document, or the number of pages constituting the document. FIG. 12 shows a constitution example of the bar size management table 27 in a case where the bar size is set with respect to the file size which is the document size. FIG. 13 shows a constitution example of the bar size management table 27 in a case where the bar size is set with respect to the page number which is the document size.

In the first constitution example of the bar size management table 27 shown in FIG. 12, the information is stored which indicates the relation between the file size and the bar size. In this case, the size of each bar indicating each document is judged by the document management table 25, first file management table 23, and bar size management table 27. That is, the file name of each document is specified by the document management table 25. The file size of the file of the file name specified by the document management table 25 is specified by the first file management table 23. The bar size in accordance with the file size specified by the first file management table 23 is determined by the bar size management table 27.

Moreover, in the second constitution example of the bar size management table 27 shown in FIG. 13, the information is stored which indicates the relation between the page size and the bar size. In this case, the size of each bar indicating each document is judged by the document management table 25 and the bar size management table 27. That is, the page number of each document is specified by the document management table 25. The bar size in accordance with the page number specified by the document management table 25 is determined by the bar size management table 27.

Next, the registration of the document management information will be described in the document managing apparatus 1.

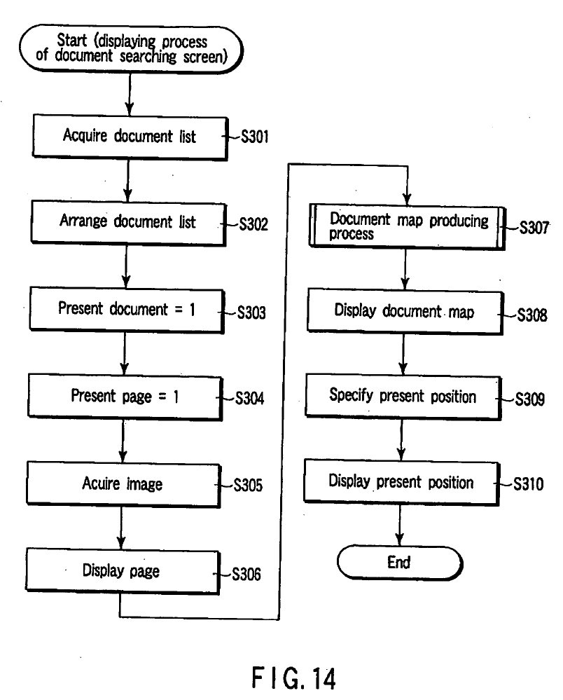

FIG. 14 is a flowchart showing a registering process of the document management information in the document managing apparatus 1.

First, to start the document managing apparatus 1, that is, to start the program 29 for document management by a PC which is the document managing apparatus 1, the CPU 11 first reads as previous file information the first file management table 23 in the HDD 15 (step S101). When the first file management table 23 is read, the CPU 11 reads as present file information the second file management table 24 in the HDD 15 (step S102).

On reading the first and second file management tables 23, 24, the CPU 11 performs a difference file detecting process to detect a difference between the management information (previous file information) of all files stored in the first file management table 23 and that (present file information) of all the files stored in the second file management table 24 (step S103). The information indicating a difference file detected by the difference file detecting process is temporarily stored, for example, in the RAM 12 or the like.

The difference file detecting process is a process to extract a file updated between a preparation time of the previous file information and the present time, or a newly added file. It is to be noted that the access time is not assumed as an object to be detected as the difference file in the present embodiment.

That is, the file which does not exist in the previous file information but which exists in the present file information, that is, the file existing only in the second file management table 24 is judged as the newly added file.

Moreover, the file whose update time in the present file information is different from that in the previous file information, that is, the file having the different update time in the first and second file management tables 23, 24 is judged as the updated file.

It is to be noted that the file which does not exist in the present file information but which exists in the previous file information, that is, the file existing only in the first file management table 23 is judged as a deleted file.

For example, a detecting process of the difference file by the first file management table 23 shown in FIG. 6 and the second file management table 24 shown in FIG. 7, three files having file names “file8.txt”, “file10.doc”, “file11.xls” are detected as the difference files.

In this case, as to the file (file name “file8.txt”) whose path is “C:\folder2\file8.txt”, the update date differs. Therefore, the file having the file name “file8.txt” is judged as the updated file.

The file (file name “file10.doc”) whose path is “C:\folder3\file10.doc”, and the file (file name “file11.xls”) whose path is “C:\folder4\file11.xls” exist only in the second file management table 24. Therefore, the files whose file names are “file10.doc” and “file11.xls” are judged as newly added files.

When the difference file is detected by the above-described difference file detecting process (step S104, YES), the CPU 11 successively reads the management information of the detected difference file to perform an updating process of the document management table 25 (steps S105 to S112). This updating process of the document management table 25 is repeatedly executed until the process is completed with respect to all the difference files detected by the difference file detecting process.

That is, when there is a difference file detected by the difference file detecting process (step S104, YES), the CPU 11 reads out one piece of management information of the difference file detected by the difference file detecting process (step S105). On reading out one difference file, the CPU 11 judges whether the difference file is the updated file (file whose update time has been changed) or the newly added file (step S106).

When it is judged that the read difference file is the updated file (step S106, YES), the CPU 11 updates the management information of the document corresponding to the file in the document management table 25 (step S107).

When it is judged that the read difference file is not the updated file, that is, when it is judged that the difference file is the newly added file (NO in the step S106), the CPU 11 judges whether or not the difference file is stored in a newly prepared folder (new folder) (step S108). In this judgment, it is judged whether or not the folder in which the file is stored is a folder in which the color is managed by the color management table 26 to thereby judge whether or not the folder is a new folder. That is, the folder whose color is set in the color management table 26 is judged as the existing folder.

For example, as to the file whose path is “C:\folder3\file10.doc”, the color is already assigned to the folder “C:\folder3” in the color management table shown in FIG. 11. In this case, it is judged that the folder “C:\folder3” is not a new folder. On the other hand, as to the file whose path is “C:\folder4\file11.xls.”, any color is not assigned to the folder “C:\folder4” in the color management table shown in FIG. 11. In this case, it is judged that the folder “C:\folder4” is a new folder.

When it is judged that the folder is the new folder (step S108, YES), the CPU 11 produces the color to be assigned to the new folder (step 109). For example, it is assumed that a new color that is not assigned to any other folder is assigned to the new folder. A unique color ID is assigned to the produced color. On producing the color to be assigned to the new folder, the CPU 11 adds, to the color management table 26, the color information in which the color is associated with the color ID as the color information with respect to the new folder (step S110).

On adding the color information with respect to the new folder in which the difference file is stored, the CPU 11 performs a new document adding process to add to the document management table 25 the management information of the document corresponding to difference file (step S112).

Moreover, when it is judged that the folder is not the new folder (step S108, NO), by the color management table 26, the CPU 11 acquires the color ID to be assigned to the folder in which the file is stored (step S111). In this case, the CPU 11 performs the new document adding process to add to the document management table 25 the management information of the document corresponding to the difference file (step S112).

Furthermore, in the new document adding process of the steps S111 and S112, the management information of the document corresponding to the newly added file is produced with reference to the second file management table 24 and the color management table 26.

For example, the update time of the difference file is used in the document time in the management information of the document. The path of the difference file is used in the file name in the management information of the document. Newly produced unique information is used in the document ID in the management information of the document in such a manner as to be distinguished from the existing document. In the color ID in the management information of the document, the color ID of the color is used, this color being associated with the folder in which the difference file is stored. Additionally, a page-number column is blank in the management information of the document, and the state is set to be “updated” in the management information of the document. Accordingly, to produce image data from the file by an image producing process described later, the page number is determined in the management information of the document.

Additionally, in a case where the difference file is not detected by the difference file detecting process, or the process is completed with respect to all the difference files detected by the difference file detecting process (step S104, NO). The CPU 11 stores in the first file management table 23 the information stored as file information at this starting time in the existing second file management table 24 (step S113). Therefore, in the first file management table 23, file memory is stored in performing the difference file detecting process (this starting time). Accordingly, the information stored in the first file management table 23 is used as the previous file information at the next starting time.

By the above-described process, the management information of the document corresponding to the updated file and that of the document corresponding to the newly added file are registered in the document management table 25, while the states of the information are set to be “updated”. It is to be noted that the document having the “updated” state is brought into the “completed” state by a document image producing process described later, and the page number is determined.

Next, the document image producing process will be described.

In the registering process of the document management information, the management information of the documents corresponding to the updated file and the newly registered file, respectively, are registered as the information having the “updated” state in the document management table 25. The file having the “updated” state indicates that an image for display is not produced. Therefore, as to a document whose “state” is “updated”, the image for display needs to be produced. This process to produce the image for display of the document is referred to as the image producing process.

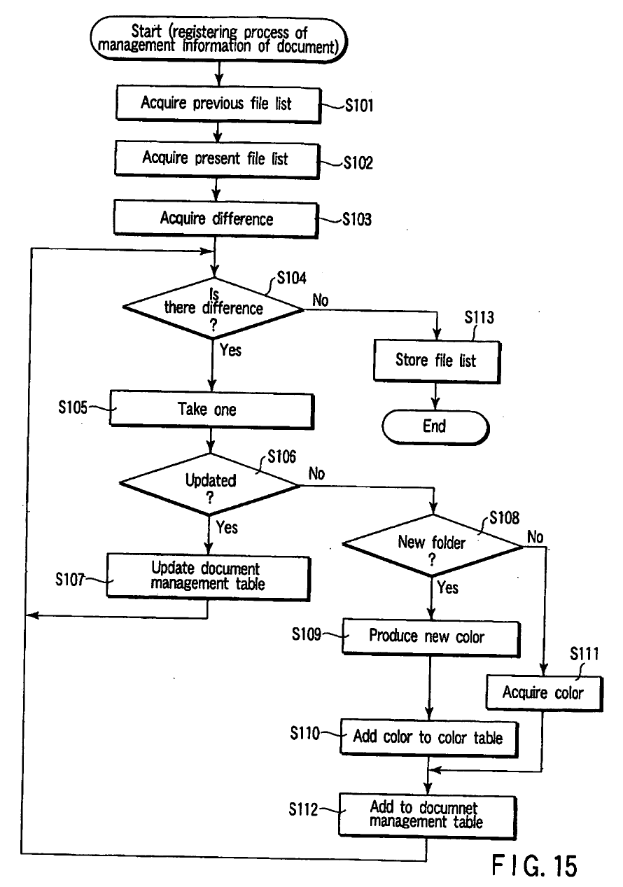

FIG. 15 is a flowchart showing an image producing process in the document managing apparatus 1.

That is, when the above-described registering process is completed with respect to the document management information, the CPU 11 performs the image producing process to produce an image for display. When the image producing process is started, the CPU 11 reads the management information of all documents from the document management table 25 (step S201). On reading the management information of the document from the document management table 25, the CPU 11 arranges the management information of all the documents based on the document time in the management information of each document (step S202). Accordingly, in the document management table 25, the management information of all the documents is rearranged in order of document time (in order of time series). For example, in the example shown in FIG. 9, three newest documents are brought into the “updated” state.

On arranging the management information of the document in the document management table 25 based on the document time, the CPU 11 judges whether or not the document (non-processed document) exists which is not subjected to the image producing process (step S203). When it is judged in this judgment that the non-processed document exists, the CPU 11 reads out the management information of the non-processed document every document (step S204). At this time, the CPU 11 first reads out a new time-series document.

On reading out the management information of one non-processed document, the CPU 11 judges whether or not the “state” is “updated” in the management information of the read document (step S205). When it is judged by the judgment that the “state” is “updated” (step S205, YES), the CPU 11 produces the image for display of the document (step S206).

It is to be noted that in this image producing process, a bitmap image is produced with respect to each page constituting the document as the image for display of the document. It is assumed in the present embodiment that image data for display of the document is prepared as image data for printing. The data of each document is formed in various forms such as text data and image data.

In the document managing apparatus 1, a document constituted of various modes of data is regarded as a management object. Therefore, in the document managing apparatus 1, data of each page constituting the document is produced as the image data for printing. As to the data having various forms used in various application programs, an image for printing is usually prepared in the application program. For example, when the document is the text data, the image for display of the document is produced, for example, as the image for printing by the application program of a word processor.

When the image data for printing is produced by this image producing process, the CPU 11 stores the image (image data for display of each page) of each page constituting the document as the file of the image data in the HDD 15 (step S207). Accordingly, the file of the image data as many as the pages of the document is stored in the HDD 15. On storing in the HDD 15 the file of the image data of each page of the document, the CPU 11 changes the “state” to the “completed” state in the management information of the document of the document management table 25. Furthermore, the CPU 11 specifies the page number from the file number produced as the image data, and sets the page number as the management information of the document in the document management table 25 (step S209).

Moreover, when there is not any non-processed document any more, that is, the “state” of all of the documents in the document management table 25 is set to be “completed” (step S203, NO), the CPU 11 ends the image producing process.

As described above, in the present embodiment, the image data for display of each document is produced as one file for each page of the document. The image data for display of each document may have any form such as TIF, PDF. A JPEG form is used in the present embodiment.

Additionally, as to each file of the image data for display, which is an image of each page, the file name can be specified from the document ID and the page number. For example, the file of the image data for display is stored with a file name “document ID-page number.jpg”.

For example, it is assumed that the document of “C:\folder4\file11.xls” comprises three pages of images in the document management table 25 shown in FIG. 9. In this case, in the producing process of the image for display concerning the document “C:\folder4\file11.xls”, the image data for display of three pages (file of three image data having the JPEG form) is produced.

Moreover, as to the document “C:\folder4\file11.xls”, as shown in FIG. 9, the document ID is “1011”. Therefore, as the image data for display of the document “C:\folder4\file11.xls”, three files having file names “1011-001.jpg”, “1011-002.jpg”, and “1011-003.jpg” are produced.

In this case, in the management information of the document whose document ID is “1011” in the document management table 25 shown in FIG. 9, as shown in FIG. 10, the “state” is set to be “completed”, and the “page number” is set to “3”. It is to be noted that FIG. 10 shows an example of the document management table 25 in a case where the image producing process is completed with respect to the document management table 25 having the state shown in FIG. 9.

It is to be noted that the image producing process may be executed in parallel with another process. That is, the image producing process may be executed in background of another process. For example, when there are many documents having the “updated” state, or there are many pages in the document whose “state” is “updated”, there is a possibility that much time is required for the image producing process. Therefore, even if the image producing process is being executed, the CPU 11 may perform a displaying process or the like of the document searching screen 40 described later.

Next, a displaying process will be described in a case where the document searching screen 40 (display window for document searching) is displayed.

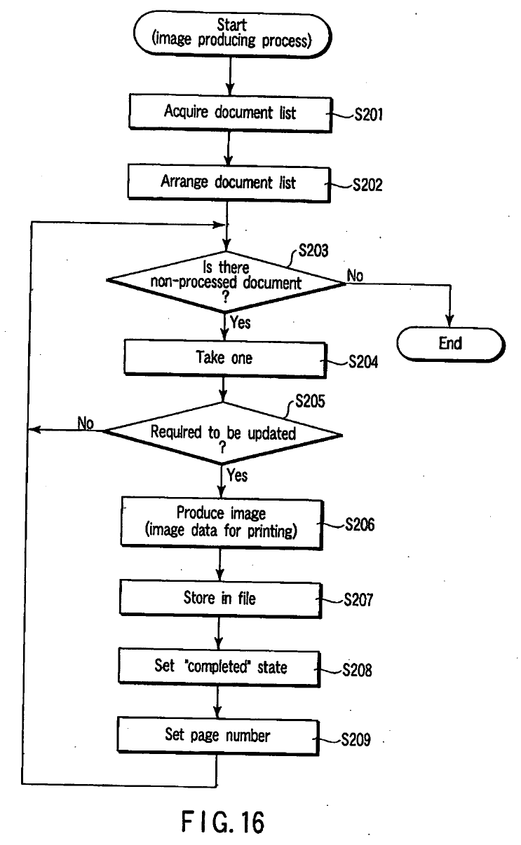

FIG. 16 is a flowchart showing a displaying process of the document searching screen 40.

First, to display (start) the document searching screen 40, the CPU 11 first reads management information of all the documents stored in the document management table 25 (step S301). On reading the management information of all the documents stored in the document management table 25, the CPU 11 arranges the management information of all the read documents in order (in order of time series) from a latest document time (step S302).

When the management information of all the documents is arranged in order of time series, the CPU 11 secures, for example, a storage region for a present document (displayed document) which stores information indicating the present displayed document on the RAM 12. On securing the storage region of the present document, the CPU 11 sets information indicating a newest document in the storage region for the present document (step S303). Here, it is assumed that an “order” in which the document is stored as the management information in the document management table 25 is set as the information indicating the present document in the storage region of the present document. In other words, the CPU 11 indicates the presently displayed document (present document) by the “order” given to each document.

Furthermore, the CPU 11 secures, for example, a storage region for a present page (displayed page) which stores information indicating the presently displayed page number of the document on the RAN 12. On securing the storage region of the present page, the CPU 11 sets information indicating a representative page (first page in the present embodiment) in the storage region for the present page (step S304). Here, it is assumed that the page number is set as the information indicating the present page in the storage region of the present page.

That is, the CPU 11 displays the representative page (first page) of the newest document as an image of initial display. Therefore, the CPU 11 sets the present document as “1”, and sets the present page as “1”. On setting the present document to “1” and the present page to “1”, the CPU 11 acquires the file of the image data for display of the page (image of the page “1” in the document having the order “1”) (step S305).

In this image acquiring process, the file of the image data of the page to be displayed is specified with reference to the document management table 25. That is, the CPU 11 acquires the document ID corresponding to the “order” (“1” in this case) set as the present document with reference to the document management table 25. On acquiring the document ID of the present document, the CPU 11 specifies the file of the image data constituted of the document ID of the present document and the page number by the “page number” (“1” in this case) set as the specification.

For example, in the example of the document management table 25 shown in FIG. 10, the document ID having the “order” “1” is “1011”. In this case, the image file of the first page of the document ID “1011” is stored with the name “1011-001.jpg”. Therefore, when the present document is set as “1”, and the present page is set as “1”, the CPU 11 specifies “1011-001.jpg” as the file of the image data with reference to the document management table 25 shown in FIG. 10.

On acquiring the file of the image data by the above-described image acquiring process, the CPU 11 displays the image data of the file in the image display region 41 of the document searching screen 40 (step S306). On displaying the image data of the acquired file in the image display region 41, the CPU 11 performs a document map producing process to produce the document map 42 stacked/displayed based on the order (order of the document time of each document in the present embodiment) of all the documents (step S307). This document map producing process will be described later in detail.

On producing the document map 42 by the document map producing process, the CPU 11 displays the produced document map 42 in a predetermined display region in the document searching screen 40 (step S308). On displaying the document map 42 in the document searching screen 40, the CPU 11 specifies the position of the present document in the document map 42 (step S309). On specifying the position of the present document, the CPU 11 displays the pointer 43 indicating the position of the present document in the document map 42 (step S310).

By the above-described displaying process of the document searching screen, an initial screen is displayed as the document searching screen 40 in the display window in the display 17.

Next, the document map producing process will be described.

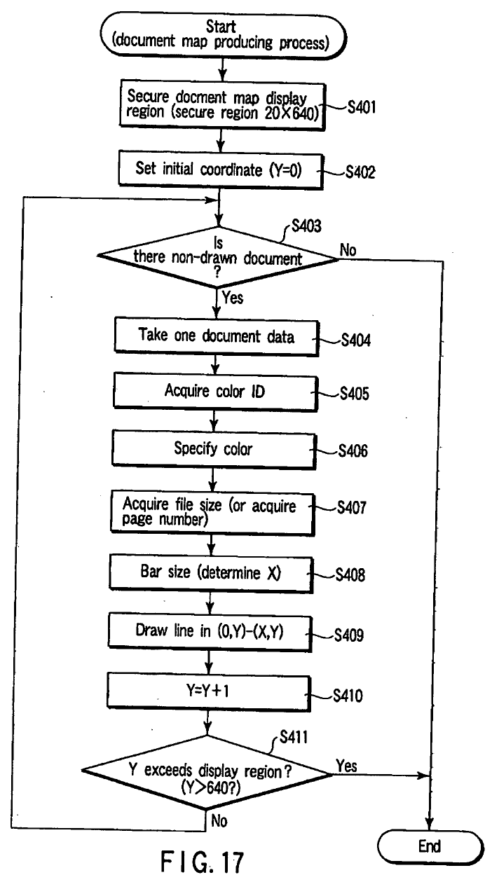

FIG. 17 is a flowchart showing the document map producing process.

On starting the producing process of the document map 42, the CPU 11 secures a display region for displaying the document map 42 in the document searching screen 40 (step S401). It is assumed that the display region of the document map 42 is set beforehand. In the step S401, it is assumed that the CPU 11 displays the secured display region of the document map 42 in a color which is an initial value, such as white.

For example, as shown in FIG. 3, the display region of the document map 42 is set as a right-end region of the document searching screen 40, which is sized in such a manner as to have a width of 20 pixels and a height of 640 pixels. It is to be noted that here, as shown in FIG. 3, the display region of the document map 42 is a rectangular region represented by coordinate value (X, Y) including four points (0, 0), (20, 0), (0, 640), (20, 640). It is to be noted that in the present embodiment, a Y-direction is defined as a vertical direction and an X-direction is defined as a lateral direction in the document searching screen shown in FIG. 3.

On securing the display region of the document map 42 in the document searching screen 40, the CPU 11 sets an initial coordinate value to start drawing (step S402). Here, as to the initial coordinate value, it is assumed that a Y-coordinate is set to “0” (Y=0) as an uppermost end of the display region of the document map 42.

On setting the initial coordinate value, the CPU 11 reads out the management information of the document from a small “order” in order from the document management table 25. That is, the CPU 11 judges whether or not a document (non-drawn document) whose bars are not drawn in the display region of the document map 42 exists in the document management table 25. When it is judged by this judgment that there is the non-drawn document in the document management table 25 (step S403), the CPU 11 reads out the management information of the document having a smallest “order” among the non-drawn documents (step S404).

On reading the management information of the document, the CPU 11 specifies the color ID assigned to the read document (step S405). On specifying the color ID of the document, the CPU 11 determines the actual color corresponding to the color ID of the document with reference to the color management table 26 (step S406). Accordingly, the determined color is a color in which the bar (line) indicating the document is drawn in the document map 42.

On judging the colors in which the bars 51, . . . indicating the respective document are drawn, the CPU 11 performs a bar size judging process to specify the sizes of the bars 51, . . . (steps S407, S408). In the present embodiment, it is assumed that the bar size judged by the bar size judging process is a length in an X-direction. That is, the judging process of the bar size determines the length of the lateral direction of each of the bars 51, . . . displayed in the document map 42.

In a case where the bar size is set in accordance with the file size as in the bar size management table 27 shown in FIG. 12, the CPU 11 first specifies the file name of the document by the document management table 25 in the bar size judging process. When the file name of the document is specified, the CPU 11 specifies the file size of the file having the specified file name by the first file management table 23. Accordingly, the CPU 11 acquires the file size as the document size (step S407). On acquiring the file size of the document, the CPU 11 determines the sizes of the bars 51, . . . in accordance with the file size by the bar size management table 27 (step S408). The size of each of the bars 51, . . . determined in this manner is “X”.

Moreover, in a case where the bar size is set in accordance with the page number as in the bar size management table 27 shown in FIG. 13, the CPU 11 first acquires the page number of the document by the document management table 25 in the bar size judging process (step S407). On acquiring the page number of the document, the CPU 11 determines the sizes of the bars 51, . . . in accordance with the acquired page number of the document by the bar size management table 27 (step S408). The size of each of the bars 51, . . . determined in this manner is “X”.

When the sizes of the bars 51, . . . are determined by the bar size judging process, the CPU 11 draws the bars 51, . . . having sizes determined in the step S408 in the color determined in the step S406 in existing Y-coordinate positions in the display region of the document map 42 (step S409).

It is assumed in the present embodiment that, as described above, the bars 51, . . . indicating the respective documents are lines each having a width (height) for one pixel in Y-direction. In this case, the CPU 11 draws the bar corresponding to the document from a coordinate value (0, Y) to (X, Y) in the display region of the document map 42. Accordingly, the bars 51, . . . each having the height for one pixel and a width of X pixels are drawn in the existing Y-coordinate positions in the document map 42. For example, since the bar 51 of the first document (document having a first “order”) indicates “Y=0”, the bar is drawn from a coordinate value (0, 0) to (X, 0) in the document map 42.

On drawing each of the bars 51, . . . indicating the document, the CPU 11 sets “Y=Y+1” to thereby increase the coordinate value in the Y-direction by one pixel (step S410). When the coordinate value in the Y-direction is increased by one pixel, the CPU 11 judges whether or not the coordinate value in the Y-direction exceed the display region of the document map 42. When it is judged by this judgment that the coordinate value of the Y-direction exceeds the display region of the document map 42 (step S411, YES), the CPU 11 ends the producing process of the document map 42.

Moreover, when it is judged by this judgment that the coordinate value of the Y-direction does not exceed the display region (step S411, NO), the CPU 11 returns to the step S403. Accordingly, the CPU 11 repeatedly executes the above-described steps S403 to S411 until there is not any more non-drawn document in the display region of the document map 42. That is, the process in the steps S403 to S411 is repeatedly executed with respect to all the documents managed by the document management table 25.

By the above-described process, the document map 42 is produced in which the bars indicating the respective documents displayed in the color corresponding to each document are stacked/displayed in the vertical direction (Y-direction) in the document searching screen 40 in the “order” (“order” based on the document time of each document) of each document managed by the document management table 25.

Next, a document searching process will be described.

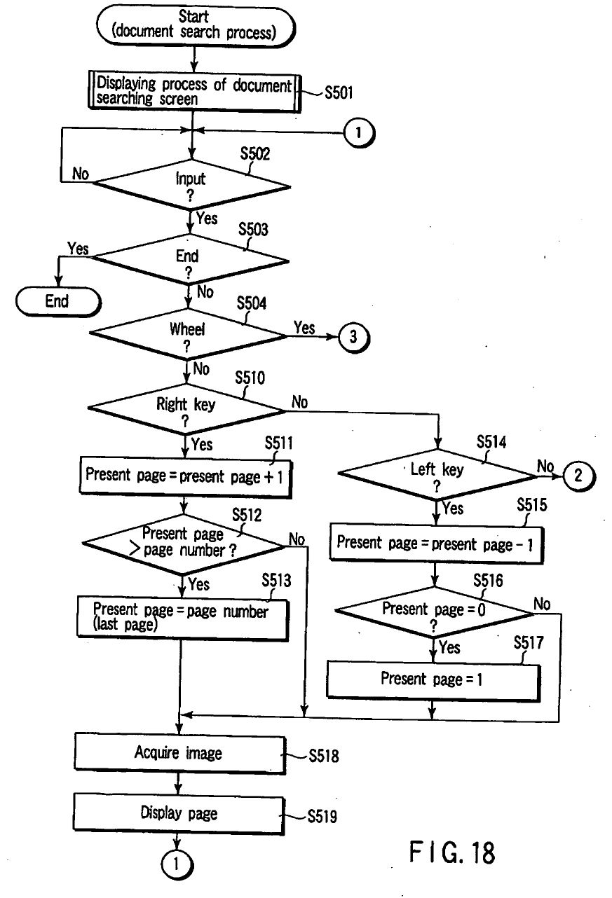

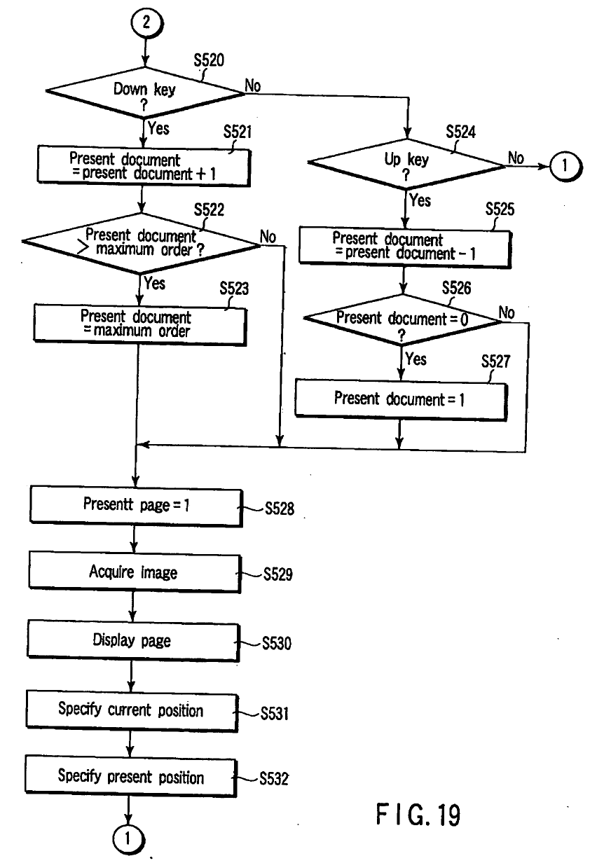

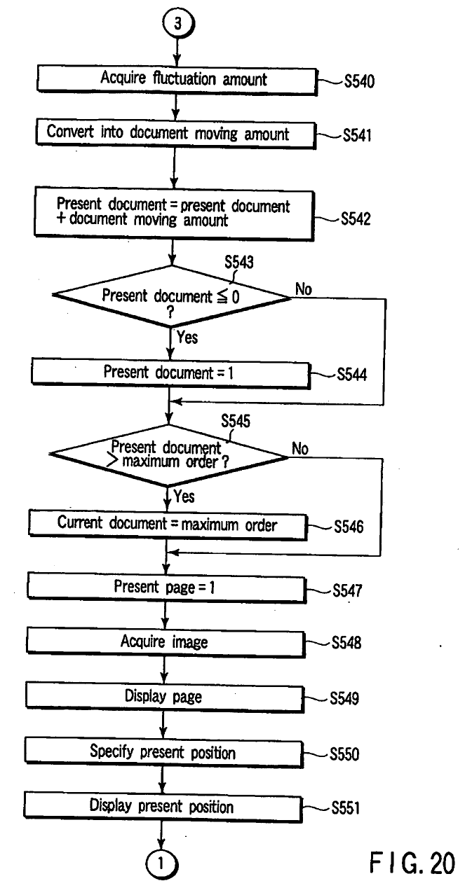

FIGS. 18, 19, 20 are flowcharts showing the document searching process.

First, it is assumed that the display 17 displays the document searching screen 40 displaying the image of the first page of the document having a latest document time by the above-described displaying process of the document searching screen (step S501). Since the process of the step S501 is similar to that of FIG. 13, description and flowchart of a sub-flow are omitted.

In this state, the CPU 11 waits for an input from a user by the mouse 19 or the keyboard 21 (step S502). In this state, the CPU 11 detects presence of an input into the mouse 19 or the keyboard 21. As to the input into the wheel 34 of the mouse 19, a rotation amount of the wheel 34 in a predetermined time is input as a fluctuation amount. As to the inputs into the respective keys of the keyboard 21 or the right/left buttons 32, 33, the key which has been input is detected.

On detecting the input into the mouse 19 or the keyboard 21 (step S502, YES), the CPU 11 judges whether or not input instruction contents indicate an instruction for end (step S503). When it is judged by this judgment that the input instruction contents indicate the instruction for the end (step S503, YES), the CPU 11 deletes the document searching screen 40 to end the process.

Moreover, when it is judged by the judgment that the input instruction contents do not indicate the instruction for the end (step S503, NO), the CPU 11 judges whether or not the input instruction contents indicate the input into the wheel 34 of the mouse 19 (step S504).

When it is judged that there is not any input into the wheel 34 of the mouse 19 (step S504, YES), the CPU 11 judges the input into the right key instructing movement to the right (step S510), the input into the left key instructing movement to the left (step S514), the input into the down key instructing downward movement (step S520), or the input into the up key instructing upward movement (step S524). It is to be noted that when the input is made into a key other than the right, left, down, and up keys, the CPU 11 returns to the step S502, and again waits for the input.

That is, when it is judged that there is an input into the right key (step S510, YES), the CPU 11 increases the present page by one to set “present page=present page+1” (step S511). In this case, the CPU 11 acquires the page number of the present document from the document management table 25, and judges whether or not the present page set in the step S511 exceeds the page number of the present document (step S512). When it is judged that the present page set in the step S511 exceeds the page number of the present document, the CPU 11 judges the present page as the page number of the present document, that is, the last page of the present document (step S513).

Moreover, when it is judged that there is an input into the left key (step S514, YES), the CPU 11 decreases the present page by one to set “present page=present page−1” (step S515). In this case, the CPU 11 judges whether or not the present page to be displayed is “0” (step S516). When it is judged that the present page set in the step S515 is “0”, the CPU 11 sets the present page to “1”, that is, the first page of the present document (step S517).

When the present page is changed by the steps S510 to S517, the CPU 11 acquires the document ID of the present document by correspondence between “order” and “document ID” in the document management table 25. On acquiring the document ID of the present document, the CPU 11 acquires the file of the image of the page by the document ID and the present page of the present document (step S518). On acquiring the file of the image of the page, the CPU 11 displays the image of the page in the image display region 41 of the document searching screen 40 (step S519).

Furthermore, when it is judged that there is an input into the down key (step S520, YES), the CPU 11 increases the present page by one to set “present document=present document+1” (step S521). In this case, the CPU 11 acquires a maximum order (“order” of the document having an oldest document time) from the document management table 25, and judges whether or not the present document set in the step S521 exceeds the maximum order (step S522). When it is judged here that the present document set in the step S521 exceeds the maximum order, the CPU 11 judges the document having the maximum order, that is, the oldest document time as the present document (step S523).

Moreover, when it is judged that there is an input into the up key (step S524, YES), the CPU 11 decreases the present document by one to set “present document=present document−1” (step S525). In this case, the CPU 11 judges whether or not the present document set in the step S525 is “0” (step S526). When it is judged that the present document set in the step S525 is “0”, the CPU 11 sets the document page to “1”, that is, the document having the latest document time (step S527).

When the present document is changed by the steps S520 to S527, the CPU 11 sets the present page to “1” which is the representative page of each document (step S519). When the present document and the present page are set in this manner, the CPU 11 acquires the document ID of the present document by the correspondence between the “order” and the “document ID” in the document management table 25. On acquiring the document ID of the present document, the CPU 11 acquires the file of the image of the page by the document ID and the present page of the present document (step S529). On acquiring the file of the image of the page, the CPU 11 displays the image of the page in the image display region 41 of the document searching screen 40 (step S530).

Furthermore, when the present document is changed by the above-described steps S520 to S527, the CPU 11 specifies the position of the present document in the document map 42 of the document searching screen 40 (step S531). When the position of the present document is specified, the CPU 11 displays the pointer 43 indicating the position of the present document in the document map 42 (step S532). That is, in the step S532, the CPU 11 changes the position of the pointer 43 in the document searching screen 40 to a position indicating the present document in the document map 42 specified in the step S531.

It is to be noted that the process of the steps S528 to S530 may be performed in parallel with the process of the steps S531 and 5532.

Additionally, when it is judged in the above-described judgment that there is an input into the wheel 34 of the mouse 19 (step S504, YES), the CPU 11 performs a document searching process in accordance with the rotation amount of the wheel 34 of the mouse 19.

That is, when it is judged in the judgment that there is an input into the wheel 34 of the mouse 19 (step S504, YES), the CPU 11 acquires the rotation amount of the wheel 34 within a predetermined time as a fluctuation amount (step S540). The rotation amount of the wheel 34 is detected by the mouse driver 18. The rotation amount of the wheel detected by the mouse driver 18 is notified with respect to the CPU 11. Accordingly, the CPU 11 acquires the rotation amount of the wheel 34 within the predetermined time as the fluctuation amount.

On acquiring the above-described fluctuation amount, the CPU 11 converts the acquired fluctuation amount into a document moving amount (step S541). The document moving amount indicates a moving document number and moving direction (rotation direction of the wheel). The moving document number indicates the number (number of documents to be moved) of documents to be switched. The moving direction corresponds to the rotation direction of the wheel, and indicates a direction in which the document is moved.

In the present embodiment, it is assumed that the moving direction is represented by a positive/negative value of the document moving amount. That is, when the wheel 34 is rotated in a positive direction, “document moving amount=+(moving document number)” is set, and the document moving amount is set to a positive value. When the document moving amount indicates the positive value in this manner, it is indicated that the documents are switched in “order”. When the wheel 34 is rotated in a reverse direction, “document moving amount=−(moving document number)” is set, and the document moving amount is set to a negative value. When the document moving amount indicates the negative value in this manner, it is indicated that the documents are switched in a reverse “order”.

For example, when the user rotates the wheel 34 in a forward direction, the document moving amount indicates a positive value, and it is indicated that the documents are switched in “order”. When the user rotates the wheel 34 in a reverse direction, the document moving amount indicates a negative value, and it is indicated that the documents are switched in the reverse “order”.

Moreover, a relation between the rotation amount of the wheel 34 of the mouse 19 and the fluctuation amount acquired by the CPU 11 is set beforehand by setting information. It is also assumed that a relation between the fluctuation amount and the document moving amount acquired by the CPU 11 is set by the setting information. The user may change the setting information to an arbitrary value.

For example, it is assumed that the fluctuation amount is “2880” with respect to one rotation of the wheel 34 of the mouse 19. In this case, when the document moving amount is set to “1” with respect to the fluctuation amount of “1”, 2880 documents move with respect to one rotation of the wheel 34. In this setting, a moving amount is excessively-large with respect to the document displayed in the image display region 41. To solve the problem, for example, when the moving document number is set to “1” with respect to a fluctuation amount of “120”, the document displayed in the image display region 41 is set in such a manner as to move by 24 documents by one rotation of the wheel 34.

Moreover, the wheel 34 of the mouse 19 is caught by a predetermined interval, that is, every constant rotation amount in some case. In the document managing apparatus 1 using the mouse 19 having this type of wheel 34, one document may be switched every catch interval accompanying the rotation of the wheel 34. This can be realized, when the moving document number is set to “1” with respect to the fluctuation amount corresponding to the rotation amount of the wheel 34 which is caught. In this case, one document may be switched every time the user operating the wheel 34 feels the catch.

When the fluctuation amount based on the rotation amount input into the wheel 34 is converted into the document moving amount (step S541), the CPU 11 sets the present document to a document which has been moved by the document moving amount (“present document=present document+document moving amount”) (step S542). In this case, the CPU 11 judges whether or not the present document set in the step S542 indicates “0” or less (step S5431. When it is judged that the present document set in the step S542 indicates “0” or less (step S543, YES), the CPU 11 sets the present document to “1”, that is, the document having the latest document time (step S544).

Moreover, when it is judged that the present document set in the step S542 does not indicate “0” or less (step S543, NO), the CPU 11 further acquires the maximum order (“order” of the document having the oldest document time) from the document management table 25, and judges whether or not the present document set in the step S542 exceeds the maximum order (step S545). Here, when it is judged that the present document set in the step S542 exceeds the maximum order (step S545, YES), the CPU 11 sets the present document to the maximum order, that is, the document having the oldest document time (step S546).

When the present document is changed by the steps S540 to S546, the CPU 11 sets the present page to “1” which is the representative page of each document (step S547). When the present document and the present page are set in this manner, the CPU 11 acquires the document ID of the present document by the correspondence between the “order” and the “document ID” in the document management table 25. On acquiring the document ID of the present document, the CPU 11 acquires the file of the image of the page by the document ID and the present page of the present document (step S548). On acquiring the file of the image of the page, the CPU 11 displays the image of the page in the image display region 41 of the document searching screen 40 (step S549).

Furthermore, when the present document is changed by the steps S540 to S546, the CPU 11 specifies the position of the present document in the document map 42 of the document searching screen 40 (step S550). On specifying the position of the present document, the CPU 11 displays the pointer 43 indicating the position of the present document in the document map 42 (step S551). That is, in the step S551, the CPU 11 changes the position of the pointer 43 in the document searching screen 40 to the position indicating the present document in the document map 42 specified in the S550.

It is to be noted that the process of the steps S547 to S549 may be performed in accordance with that of the steps S550 and S551. In the present embodiment, S540, S521, S525 correspond to an input control unit, and S528 to S532, S547 to S551 correspond to a display control unit.

As described above, in the process shown in FIGS. 18, 19, and 20, the fluctuation amount input by the user in accordance with the rotation amount of the wheel 34 of the mouse 19 is converted into the document moving amount, the documents arranged in order of time series are switched in accordance with the document moving amount, and the image of the document switched in accordance with the document moving amount is displayed in the display. Accordingly, the wheel 34 of the mouse 19 is rotated, and the document whose image of the first page is to be displayed can be efficiently switched. As a result, the user can efficiently search the document managed by the document managing apparatus 1, and can easily find a desired document.

As described above, in the document managing apparatus 1 of the present embodiment, the document map 42 is produced in which the respective bars 51, . . . are stacked and displayed, each bar having the size in accordance with the size of each document which is the management object. The document searching screen is displayed in the display, the screen having: the produced document map 42; the pointer 43 indicating one bar in the document map 42; and the image display region which displays the image of the document corresponding to each of the bars 51, . . . indicated by this pointer.

Accordingly, the document size can be intuitively recognized by the sizes of the bars 51, . . . displayed in the document map 42, and the document can be easily searched.

Furthermore, in the document map 42, the respective bars 51, . . . are displayed in the lengths corresponding to the respective document sizes, and stacked/displayed in order based on the document time of each document or the like. Therefore, the document size and document time can be intuitively recognized, and the document can be efficiently searched.

Furthermore, in the document map 42, the respective bars 51, . . . displayed in the lengths in accordance with the sizes of the respective documents are stacked and displayed in various colors based on the storage place of the file of each document, the data form of the file or the like. Therefore, the document size, document file storage place, file data form and the like can be intuitively recognized, and the document can be efficiently searched.

Additionally, in the present embodiment, it has been described that the fluctuation amount in accordance with the rotation amount of the whole of the mouse rotating forwards/backwards is converted into the document moving amount. However, the above-described embodiment is not limited to the wheel of the mouse. That is, the wheel of the mouse in the above-described embodiment may be replaced as long as the fluctuation amount can be input in the direction corresponding to the time axis of the document map in the display screen. For example, a pointing device such as a track ball and a touch pad may be applicable instead of the wheel of the mouse in the present embodiment.

For example, as to the touch pad, the document managing apparatus 1 may acquire as the fluctuation amount an amount by which the user traces a pad portion in a vertical direction. As to the track ball, the document managing apparatus 1 ay acquire as the fluctuation amount an amount by which the user rotates the ball in a forward/backward direction. Additionally, in a general track ball or touch pad, directivity of rotation or movement is unspecified. Therefore, the document managing apparatus 1 acquires the moving amount in the direction corresponding to the time axis of the document map as the fluctuation amount, and converts the fluctuation amount into the document moving amount so that an embodiment similar to the above-described embodiment can be realized.

It is to be noted that in the present embodiment, it has been described that the function of carrying out the present invention is recorded beforehand in the apparatus, but the present invention is not limited to this embodiment. The similar function may be downloaded to the apparatus from the network, or the similar function stored in a recording medium may be installed in the apparatus. Any mode of the recording medium may be used such as CD-ROM as long as the program can be stored, and read by the apparatus. The function obtained beforehand by the installation or download may be realized in cooperation with an internal operating system (OS) or the like of the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A document searching apparatus comprising:
document managing means for managing a size of each document which is a management object;
document map producing means for producing a document map which stacks and displays bars having sizes in accordance with the sizes of the respective documents managed by the document managing means; and
displaying means for displaying a screen having the document map produced by the document map producing means, a pointer indicating one bar in the document map, and an image display region which displays an image of the document corresponding to the bar indicated by the pointer.

2. The document searching apparatus according to claim 1, wherein the document managing means further manages an order of each document which is the management object, and
the document map producing means produces the document map which stacks and displays the respective bars corresponding to the respective documents in accordance with the order of each document managed by the document managing means.

3. The document searching apparatus according to claim 1, wherein the document map producing means determines as each bar size a length in a direction crossing a direction in which the respective bars are stacked and displayed at right angles in accordance with each document size.

4. The document searching apparatus according to claim 1, further comprising:
bar size managing means for storing information indicating a relation between the document size and the bar size,
wherein the document map producing means determines the bar size in accordance with the size of the document managed by the document managing means based on the information stored in the bar size managing means.

5. The document searching apparatus according to claim 4, wherein the document managing means manages data size of the file forming each document as the size of each document which is the management object,
the bar size managing means stores information indicating a relation between a file data size and the bar size, and
the document map producing means determines the bar size in accordance with the data size of the file of the document managed by the document managing means based on the information stored in the bar size managing means.

6. The document searching apparatus according to claim 4, wherein the document managing means determines a page number of each document as the size of each document which is the management object,
the bar size managing means stores information indicating a relation between the page number and the bar size, and
the document map producing means determines the bar size in accordance with the page number of the document managed by the document managing means based on the information stored in the bar size managing means.

7. A document searching program which allows a computer to realize:
a document managing function of managing a size of each document which is a management object;
a document map producing function of producing a document map which stacks and displays bars having sizes in accordance with the sizes of the respective documents managed by the document managing function; and
a displaying function of displaying in a display a screen having the document map produced by the document map producing function, a pointer indicating one bar in the document map, and an image display region which displays an image of the document corresponding to the bar indicated by the pointer.

8. The document searching program according to claim 7, wherein the document managing function further manages an order of each document which is the management object, and
the document map producing function produces the document map which stacks and displays the respective bars corresponding to the respective documents in accordance with the order of each document managed by the document managing function.

9. The document searching program according to claim 7, wherein the document map producing function determines as each bar size a length in a direction crossing a direction in which the respective bars are stacked and displayed at right angles in accordance with each document size.

10. The document searching program according to claim 7, further comprising:
a bar size managing function of setting information indicating a relation between the document size and the bar size,
wherein the document map producing function determines the bar size in accordance with the size of the document managed by the document managing function based on the information set by the bar size managing function.

11. The document searching program according to claim 10, wherein the document managing function manages data size of the file forming each document as the size of each document which is the management object,
the bar size managing function sets information indicating a relation between a file data size and the bar size, and
the document map producing function determines the bar size in accordance with the data size of the file of the document managed by the document managing function based on the information set by the bar size managing function.

12. The document searching program according to claim 10, wherein the document managing function manages a page number of each document as the size of each document which is the management object,
the bar size managing function sets information indicating a relation between the page number and the bar size, and
the document map producing function determines the bar size in accordance with the page number of the document managed by the document managing function based on the information set by the bar size managing function.

13. A document searching method comprising:
managing a size of each document which is a management object;
producing a document map which stacks and displays bars having sizes in accordance with the sizes of the respective managed documents; and
displaying in a display a screen having the produced document map, a pointer indicating one bar in the document map, and an image display region which displays an image of the document corresponding to the bar indicated by the pointer.

14. The document searching method according to claim 13, further comprising:
managing an order of each document which is the management object,
the producing of the document map comprising: producing the document map which stacks and displays the respective bars corresponding to the respective documents in accordance with the order of each document.

15. The document searching method according to claim 13, wherein the producing of the document map comprises: determining as each bar size a length in a direction crossing a direction in which the respective bars are stacked and displayed at right angles in accordance with each document size.

16. The document searching method according to claim 13, further comprising:
setting beforehand information indicating a relation between the document size and the bar size,
the producing of the document map comprising: determining the bar size in accordance with the size of the document which is the management object based on the information indicating the relation between the document size and the bar size.

17. The document searching method according to claim 16, wherein the size of each managed document is a data size of the file forming each document,
the information indicating the relation between the document size and the bar size is information indicating a relation between a file data size and the bar size, and
the producing of the document map comprises: determining the bar size in accordance with the data size of the file of the document which is the management object based on the information indicating the relation between the file data size and the bar size.

18. The document searching method according to claim 16, wherein the size of each managed document is a page number of each document,
the information indicating the relation between the document size and the bar size is information indicating a relation between the page number and the bar size, and
the producing of the document map comprises: determining the bar size in accordance with the page number of the document which is the management object based on the information indicating the relation between the page number and the bar size.
